(19) United States
(12) Patent Application Publication
(10) Pub. No.: US 2018/0330050 A1
(43) Pub. Date: Nov. 15, 2018

(54) DETECTING COPY NUMBER VARIATIONS

(71) Applicant: Mayo Foundation for Medical Education and Research, Rochester, MN (US)

(72) Inventor: John L. BLACK, Rochester, MN (US)

(73) Assignee: Mayo Foundation for Medical Education and Research, Rochester, MN (US)

(21) Appl. No.: 15/776,712

(22) PCT Filed: Nov. 16, 2016
(86) PCT No.: PCT/US16/62260

§ 371 Date: May 16, 2018

Related U.S. Application Data
(60) Provisional application No. 62/255,933, filed on Nov. 16, 2015.
(60) Provisional application No. 62/261,131, filed on Nov. 30, 2015.

(51) Int. Cl. G06F 19/22

(52) U.S. Cl. CPC G06F 19/22

(57) ABSTRACT

This document provides methods and materials for detecting copy number variations. For example, methods and materials for using combinations of sequencing read depth ratios calculated from next generation sequencing data to determine copy number variations for genes of interest are provided.

### CROSS-REFERENCE TO RELATED APPLICATIONS

This application claims priority to U.S. Application Ser. No. 62/261,131, filed on Nov. 30, 2015 and U.S. Application Ser. No. 62/255,933, filed on Nov. 16, 2015. The disclosure of the prior applications is considered part of the disclosure of this application, and is incorporated in its entirety into this application.

### STATEMENT AS TO FEDERALLY SPONSORED RESEARCH

This invention was made with government support under HG006379 awarded by National Institutes of Health. The government has certain rights in the invention.

### BACKGROUND

### 1. Technical Field

This document relates to methods and materials involved in detecting copy number variations. For example, this document provides methods and materials for using combinations of sequencing read depth ratios calculated from next generation sequencing data to determine copy number variations for genes of interest.

### 2. Background Information

A copy number variation is an alteration of the genome that results in the cell having an abnormal number of copies of one or more sections of the DNA. Copy number variations correspond to relatively large regions of the genome (e.g., 500 bases to 5-10 million bases) that have been deleted (e.g., fewer than the normal number) or duplicated (e.g., more than the normal number) on certain chromosomes. For example, a chromosome that normally has sections A-B-C-D in that order might instead have sections A-B-C-C-D (i.e., a duplication of “C”), A-B-D (i.e., a deletion of “C”), A-B-B-C-C-D (i.e., a duplication of both “B” and “C”), or A-B-Cₙ-D (i.e., any number of multiplication of “C” when n is greater than one).

### SUMMARY

This document provides methods and materials for detecting copy number variations. For example, this document provides methods and materials for using combinations of sequencing read depth ratios calculated from next generation sequencing data to determine copy number variations for regions of interest (e.g., genes of interest). As described herein, various ratio values of sequencing read depths obtained from next generation sequencing data of an internal standard sample or a set of training samples can be used to create ranges for assessing a sample (e.g., a human patient sample) to determine if that sample contains one or more duplicated, multiplied, or deleted genetic regions of interest (e.g., one or more duplicated, multiplied, or deleted genes of interest).

In general, one aspect of this document features a method of detecting the presence of a genetic duplication, multiplication, or deletion in a genetic region of interest of a sample. The method comprises, or consists essentially of:

(a) obtaining average read depth values (or other read depth values such as maximum read depth values, modal read depth values, minimum read depth values, or 25^{th} percentile read depth values) of next generation sequencing data for a plurality of sub-regions of the genetic region for a set of training samples known to lack the duplication, multiplication, or deletion,

(b) obtaining average read depth values (or other read depth values such as maximum read depth values, modal read depth values, minimum read depth values, or 25^{th} percentile read depth values) of the next generation sequencing data for a plurality of sub-regions of a comparison region for the set of training samples, wherein the genetic region is comparable to the comparison region, and wherein each of the plurality of sub-regions of the genetic region is comparable to one of the plurality of sub-regions of the comparison region,

(c) optionally calculating the ratio of (i) the average read depth value (or other read depth value) for each of the plurality of sub-regions of the genetic region to (ii) the average read depth value (or other read depth value) for its comparable sub-region of the comparison region to obtain a first set of ratios,

(d) optionally calculating the average for the first set of ratios to obtain a Ratio 1 value,

(e) optionally selecting one of the plurality of sub-regions of the genetic region to be a first selected sub-region, wherein the other sub-regions of the genetic region are unselected sub-regions,

(f) optionally calculating the ratio of (i) the average read depth value (or other read depth value) for each of the unselected sub-regions to (ii) the average read depth value (or other read depth value) for the first selected sub-region to obtain a second set of ratios,

(g) optionally calculating the average for the second set of ratios to obtain a Ratio 2 value,

(h) optionally selecting a second one of the plurality of sub-regions of the genetic region to be a second selected sub-region, wherein the other sub-regions of the genetic region minus the first selected sub-region are twice unselected sub-regions,

(i) optionally calculating the ratio of (i) the average read depth value (or other read depth value) for each of the twice unselected sub-regions to (ii) the average read depth value (or other read depth value) for the second selected sub-region to obtain a third set of ratios,

(j) optionally calculating the average for the third set of ratios to obtain a Ratio 3 value,

(k) optionally selecting one of the plurality of sub-regions of the comparison region to be a first selected comparable sub-region, wherein the other sub-regions of the comparison region are unselected comparison sub-regions, and wherein the first selected comparable sub-region is comparable to the first selected sub-region,

(l) optionally calculating the ratio of (i) the average read depth value (or other read depth value) for each of the unselected comparison sub-regions to (ii) the average read depth value (or other read depth value) for the first selected comparable sub-region to obtain a fourth set of ratios,

(m) optionally calculating the average for the fourth set of ratios to obtain a Ratio 4 value,

(n) optionally selecting a second one of the plurality of sub-regions of the comparison region to be a second selected comparable sub-region, wherein the other sub-regions of the comparison region minus the first selected comparable sub-region are twice unselected comparison sub-regions,

(o) optionally calculating the ratio of (i) the average read depth value (or other read depth value) for each of the twice unselected comparison sub-regions to (ii) the average read depth value (or other read depth value) for the second selected comparable sub-region to obtain a fifth set of ratios,

(p) optionally calculating the average for the fifth set of ratios to obtain a Ratio 5 value,

(q) optionally calculating the ratio of (i) the average read depth value (or other read depth value) for one selection of the plurality of sub-regions of the genetic region to (ii) the average read depth value (or other read depth value) for another selection of the plurality of sub-regions of the genetic region to obtain a Ratio 6 value,

(r) optionally calculating the ratio of (i) the average read depth value (or other read depth value) for one selection of the plurality of sub-regions of the genetic region to (ii) the average read depth value (or other read depth value) for another selection of the plurality of sub-regions of the genetic region to obtain a Ratio 7 value, wherein at least one of the one selection or the another selection of step (r) is different from the one selection and the another selection of step (q),

(s) optionally calculating the ratio of (i) the average read depth value (or other read depth value) for one selection of the plurality of sub-regions of the comparison region to (ii) the average read depth value (or other read depth value) for another selection of the plurality of sub-regions of the comparison region to obtain a Ratio 8 value,

(t) optionally calculating the ratio of (i) the average read depth value (or other read depth value) for one selection of the plurality of sub-regions of the comparison region to (ii) the average read depth value (or other read depth value) for another selection of the plurality of sub-regions of the comparison region to obtain a Ratio 9 value, wherein at least one of the one selection or the another selection of step (t) is different from the one selection and the another selection of step (s),

wherein at least two (e.g., at least three, four, five, or six) sets of optional steps selected from the group consisting of the steps (c)-(d), (e)-(g), (h)-(j), (k)-(m), (n)-(p), (q), (r), (s), and (t) are performed to obtain at least two (e.g., at least three, four, five, or six) training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, respectively,

(u) obtaining at least two (e.g., at least three, four, five, or six) ratio values for the sample that are comparable to the at least two (e.g., at least three, four, five, or six) training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, and

(v) comparing the at least two (e.g., at least three, four, five, or six) comparable ratio values for the sample obtained in step (u) to the at least two (e.g., at least three, four, five, or six) training set ratio values to identify the presence of the duplication, multiplication, or deletion. The genetic region of interest can be a CYP2D6 locus. The plurality of sub-regions of the genetic region can be a plurality of exons. At least one of the plurality of sub-regions of the genetic region can be a promoter region. The comparison region of interest can be a CYP2D7 locus. The plurality of sub-regions of the comparison region can be a plurality of exons. At least one of the plurality of sub-regions of the comparison region can be a promoter region. The next generation sequencing data can be data from next generation sequencing comprising clonal bridge amplification for template preparation and reversible dye terminators. The next generation sequencing data can be data from next generation sequencing comprising clonal-emPCR for template preparation and pyrosequencing. The next generation sequencing data can be data from next generation sequencing comprising clonal-emPCR for template preparation, and oligonucleotide chained ligation or proton detection. The next generation sequencing data can be data from next generation sequencing comprising using phospholinked fluorescent nucleotides. The method can comprise performing at least four sets of optional steps selected from the group consisting of the steps (c)-(d), (e)-(g), (h)-(j), (k)-(m), (n)-(p), (q), (r), (s), and (t) to obtain at least four training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, respectively. The method can comprise (u2) obtaining at least four ratio values for the sample that are comparable to the at least four training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, and (v2) comparing the at least four comparable ratio values for the sample obtained in step (u2) to the at least four training set ratio values to identify the presence of the duplication, multiplication, or deletion. The method can comprise performing at least five sets of optional steps selected from the group consisting of the steps (c)-(d), (e)-(g), (h)-(j), (k)-(m), (n)-(p), (q), (r), (s), and (t) to obtain at least five training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, respectively. The method can comprise (u2) obtaining at least five ratio values for the sample that are comparable to the at least five training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, and (v2) comparing the at least five comparable ratio values for the sample obtained in step (u2) to the at least five training set ratio values to identify the presence of the duplication, multiplication, or deletion. The method can comprise performing at least six sets of optional steps selected from the group consisting of the steps (c)-(d), (e)-(g), (h)-(j), (k)-(m), (n)-(p), (q), (r), (s), and (t) to obtain at least six training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, respectively. The method can comprise (u2) obtaining at least six ratio values for the sample that are comparable to the at least six training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, and (v2) comparing the at least six comparable ratio values for the sample obtained in step (u2) to the at least six training set ratio values to identify the presence of the duplication, multiplication, or deletion. The method can comprise performing at least seven sets of optional steps selected from the group consisting of the steps (c)-(d), (e)-(g), (h)-(j), (k)-(m), (n)-(p), (q), (r), (s), and (t) to obtain at least seven training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, respectively. The method can comprise (u2) obtaining at least seven ratio values for the sample that are comparable to the at least seven training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, and (v2) comparing the at least seven comparable ratio values for the sample obtained in step (u2) to the at least seven training set ratio values to identify the presence of the duplication, multiplication, or deletion. The method can comprise performing at least eight sets of optional steps selected from the group consisting of the steps (c)-(d), (e)-(g), (h)-(j), (k)-(m), (n)-(p), (q), (r), (s), and (t) to obtain at least eight training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, respectively. The method can comprise (u2) obtaining at least eight ratio values for the sample that are comparable to the at least eight training set ratio values selected from the group consisting of the Ratio 1 value, the Ratio 2 value, the Ratio 2 value, the Ratio 4 value, the Ratio 5 value, the Ratio 6 value, the Ratio 7 value, the Ratio 8 value, and the Ratio 9 value, and (v2) comparing the at least eight comparable ratio values for the sample obtained in step (u2) to the at least eight training set ratio values to identify the presence of the duplication, multiplication, or deletion.

In another aspect, this document features a method of detecting the presence of a genetic duplication, multiplication, or deletion in a genetic region of interest of a sample. The method comprises, or consists essentially of:

(a) obtaining average read depth values (or other read depth values such as maximum read depth values, modal read depth values, minimum read depth values, or 25^{th} percentile read depth values) of next generation sequencing data for a plurality of sub-regions of the genetic region for a set of training samples known to lack the duplication, multiplication, or deletion,

(b) obtaining average read depth values (or other read depth values such as maximum read depth values, modal read depth values, minimum read depth values, or 25^{th} percentile read depth values) of the next generation sequencing data for a plurality of sub-regions of a comparison region for the set of training samples, wherein the genetic region is comparable to the comparison region, and wherein each of the plurality of sub-regions of the genetic region is comparable to one of the plurality of sub-regions of the comparison region,

(c) calculating the ratio of (i) the average read depth value (or other read depth values) for each of the plurality of sub-regions of the genetic region to (ii) the average read depth value (or other read depth values) for its comparable sub-region of the comparison region to obtain a first set of ratios,

(d) calculating the average for the first set of ratios to obtain a Ratio 1 value,

(e) selecting one of the plurality of sub-regions of the genetic region to be a first selected sub-region, wherein the other sub-regions of the genetic region are unselected sub-regions,

(f) calculating the ratio of (i) the average read depth value (or other read depth values) for each of the unselected sub-regions to (ii) the average read depth value (or other read depth values) for the first selected sub-region to obtain a second set of ratios,

(g) calculating the average for the second set of ratios to obtain a Ratio 2 value,

(h) selecting a second one of the plurality of sub-regions of the genetic region to be a second selected sub-region, wherein the other sub-regions of the genetic region minus the first selected sub-region are twice unselected sub-regions,

(i) calculating the ratio of (i) the average read depth value (or other read depth values) for each of the twice unselected sub-regions to (ii) the average read depth value (or other read depth values) for the second selected sub-region to obtain a third set of ratios,

(j) calculating the average for the third set of ratios to obtain a Ratio 3 value,

(k) selecting one of the plurality of sub-regions of the comparison region to be a first selected comparable sub-region, wherein the other sub-regions of the comparison region are unselected comparison sub-regions, and wherein the first selected comparable sub-region is comparable to the first selected sub-region,

(l) calculating the ratio of (i) the average read depth value (or other read depth values) for each of the unselected comparison sub-regions to (ii) the average read depth value (or other read depth values) for the first selected comparable sub-region to obtain a fourth set of ratios,

(m) calculating the average for the fourth set of ratios to obtain a Ratio 4 value,

(n) selecting a second one of the plurality of sub-regions of the comparison region to be a second selected comparable sub-region, wherein the other sub-regions of the comparison region minus the first selected comparable sub-region are twice unselected comparison sub-regions,

(o) calculating the ratio of (i) the average read depth value (or other read depth values) for each of the twice unselected comparison sub-regions to (ii) the average read depth value (or other read depth values) for the second selected comparable sub-region to obtain a fifth set of ratios,

(p) calculating the average for the fifth set of ratios to obtain a Ratio 5 value,

(q) calculating the ratio of (i) the average read depth value (or other read depth values) for one selection of the plurality of sub-regions of the genetic region to (ii) the average read depth value (or other read depth values) for another selection of the plurality of sub-regions of the genetic region to obtain a Ratio 6 value,

(r) calculating the ratio of (i) the average read depth value (or other read depth values) for one selection of the plurality of sub-regions of the genetic region to (ii) the average read depth value (or other read depth values) for another selection of the plurality of sub-regions of the genetic region to obtain a Ratio 7 value, wherein at least one of the one selection or the another selection of step (r) is different from the one selection and the another selection of step (q),

(s) calculating the ratio of (i) the average read depth value (or other read depth values) for one selection of the plurality of sub-regions of the comparison region to (ii) the average read depth value (or other read depth values) for another selection of the plurality of sub-regions of the comparison region to obtain a Ratio 8 value,

(t) calculating the ratio of (i) the average read depth value (or other read depth values) for one selection of the plurality of sub-regions of the comparison region to (ii) the average read depth value (or other read depth values) for another selection of the plurality of sub-regions of the comparison region to obtain a Ratio 9 value, wherein at least one of the one selection or the another selection of step (t) is different from the one selection and the another selection of step (s),

(u) obtaining comparable Ratio 1-9 values for the sample, and

(v) comparing the comparable Ratio 1-9 values of the sample to the Ratio 1-9 values of the set of training samples to identify the presence of the duplication, multiplication, or deletion. The genetic region of interest can be a CYP2D6 locus. The plurality of sub-regions of the genetic region can be a plurality of exons. At least one of the plurality of sub-regions of the genetic region can be a promoter region. The comparison region of interest can be a CYP2D7 locus. The plurality of sub-regions of the comparison region can be a plurality of exons. At least one of the plurality of sub-regions of the comparison region can be a promoter region. The next generation sequencing data can be data from next generation sequencing comprising clonal bridge amplification for template preparation and reversible dye terminators. The next generation sequencing data can be data from next generation sequencing comprising clonal-emPCR for template preparation and pyrosequencing. The next generation sequencing data can be data from next generation sequencing comprising clonal-emPCR for template preparation, and oligonucleotide chained ligation or proton detection. The next generation sequencing data can be data from next generation sequencing comprising using phospholinked fluorescent nucleotides.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIGS. 1A-C are diagrams of exemplary CYP2D locus structures for single (FIG. 1A), typical duplicated/multiplied (FIG. 1B), or deleted arrangements (FIG. 1C). The section between the brackets (“[” and “]”) in FIG. 1B can be multiplied.

FIGS. 2A-F are diagrams of exemplary CYP2D locus structures for single and hybrid tandem duplications or multiplications in the CYP2D locus involving a CYP2D6-2D7 gene. The section between the brackets (“[” and “]”) can be multiplied.

FIG. 3A-E are diagrams of exemplary CYP2D locus structures for single and hybrid tandem duplications or multiplications in the CYP2D locus involving a CYP2D7-2D6 gene. The section between the brackets (“[” and “]”) can be multiplied.

FIG. 4 is a table showing the calculation of the ratio 1 series along with Ratio 1A, Ratio 1B, Ratio 1C, and Ratio 1D. Any one of Ratio 1A, Ratio 1B, Ratio 1C, Ratio 1D, or another subset (e.g., only seven of the ten discussed cells) can be used as Ratio 1.

FIG. 5 is a table showing the calculation of Ratio 2.

FIG. 6 is a table showing the calculation of Ratio 3.

FIG. 7 is a table showing the calculation of Ratio 4.

FIG. 8 is a table showing the calculation of Ratio 5.

FIG. 9 is a table showing the calculation of Ratios 6 and 7.

FIG. 10 is a table showing the calculation of Ratios 8 and 9.

FIG. 11 is a table showing the +/−2 and +/−3 standard deviation calculations for an example of a training set of 45 samples.

FIG. 12 is a table showing the predicted ratio results for the indicated locus arrangements of FIGS. 1-3.

FIG. 13 is a table showing the results for the ratio values for a sample having the indicated arrangement.

FIG. 14 is a table showing a comparison of clinical Luminex and CYP2D6 cascade testing to one embodiment of the methods provided herein.

### DETAILED DESCRIPTION

This document provides methods and materials for detecting copy number variations. For example, this document provides methods and materials for using combinations of sequencing read depth ratios calculated from next generation sequencing data to determine copy number variations for one or more genomic regions of interest (e.g., a gene of interest).

The methods and materials provided herein can be used to assess any region of interest of a genome. Examples of regions of interest that can be assessed as described herein include, without limitation, genes partially or in their entirety, intragenic regions, polypeptide-encoding regions, regulatory components of a genome, introns, exons, promoter regions, 3′ untranslated regions, and genomic areas encoding microRNAs. Other examples of regions of interest that can be assessed as described herein include, without limitation, those parts of a genome that are described in the CNVannotator (http://bioinfo.mc.vanderbilt.edu/CNVannotator/; Zhao and Zhao, PLoS ONE, 8(11):1-8 (2013)) as undergoing copy number variation. In some cases, a region of interest that can be assessed for a copy number variation as described herein can be a gene or a portion thereof (e.g., a portion of at least 30 bases in length, at least 50 bases in length, at least 100 bases in length, at least 500 bases in length, at least 1 kb in length, at least 1.5 kb in length, at least 2 kb in length, at least 2.5 kb in length, at least 3 kb in length, at least 4 kb in length, or at least 5 kb in length) such as a CYP2D6, CYP2A6, CYP2B6, CYP3A4, CYP8A1, or CYP21A2 gene. In some cases, a region of interest that can be assessed for a copy number variation as described herein can be at least 30 bases in length, at least 50 bases in length, at least 100 bases in length, at least 500 bases in length, at least 1 kb in length, at least 1.5 kb in length, at least 2 kb in length, at least 2.5 kb in length, at least 3 kb in length, at least 4 kb in length, or at least 5 kb in length.

The presence of a copy number variation can be assessed as described herein using a sample obtained from any appropriate organism (e.g., a mammal) or virus. For example, the methods and materials provided herein can be used to detect the presence of a copy number variation for a gene (or portion thereof) in a human, monkey, horse, a bovine species, sheep, goat, pig, dog, cat, mouse, rat, bacterium, virus, or a plant species.

As described herein, the presence of a genetic duplication, multiplication, or deletion in a genetic region of interest of a sample can be determined using combinations of sequencing read depth ratios calculated from next generation sequencing data. Any appropriate next generation sequencing data can be used. For example, next generation sequencing data obtained using (a) phospholinked fluorescent nucleotides (e.g., the Pacific Biosciences SMRT platform), (b) clonal-emPCR for template preparation and pyrosequencing (e.g., the Roche 454 platform), (c) clonal bridge amplification for template preparation and reversible dye terminators (e.g., the Illumina MiSeq, HiSeq, or Genome Analyzer IIX platforms), (d) clonal-emPCR for template preparation and oligonucleotide 8-mer chained ligation (e.g., the Life Technologies SOLiD4 platform), (e) clonal-emPCR for template preparation and proton detection (e.g., the Life Technologies Ion Proton platform), or (f) gridded DNA-nanoballs and oligonucleotide 9-mer unchained ligation (e.g., the Complete Genomics platform) can be used as described herein.

In general, the next generation sequencing data is assessed to determine read depth values for a plurality of sub-regions (e.g., promoter regions, exons, introns, or combinations thereof) of a genetic region of interest (e.g., a gene) and a plurality of comparable sub-regions (e.g., promoter regions, exons, introns, or combinations thereof) of a genetic comparison region of interest (e.g., a comparison gene). In some cases, any appropriate genetic region that is located at a locus of the genome that is different from that of the genetic region of interest can be used as a genetic comparison region of interest. For example, when assessing a CYP2D6 gene of interest, the comparison gene can be its pseudogene (e.g., CYP2D7). Other genes of interest and possible comparison genes are set forth in Table 1.

TABLE 1
Genes of interest and possible comparison genes.

| Gene of interest | Comparison gene |
|---|---|
| CYP2D6 | CYP2D7 |
| CYP2A6 | CYP2A7 |
| CYP2B6 | CYP2B7 |
| CYP3A4 | CYP3A5 or CYP3A7 |
| CYP8A1 | CYP3A4, 5, or 7 |
| CYP21A2 | CYP21A1P |

In some cases, a parameter (e.g., average read depth) of a comparison region can be replaced with a parameter (e.g., average read depth) for the entire lot of sequencing data or a subset thereof. For example, when using the average read depth values for a plurality of sub-regions (e.g., promoter regions, exons, introns, or combinations thereof) of a genetic region of interest (e.g., a gene) as described herein, the average read depth for the entire next generation sequencing reaction can be used in place of the average read depth values of a plurality of comparable sub-regions (e.g., promoter regions, exons, introns, or combinations thereof) of a genetic comparison region of interest (e.g., a comparison gene). In some cases, a subset of the entire lot of sequencing data can be used. For example, the average read depth values of a chromosome, a set of chromosomes, a chromosome arm, a set of chromosome arms, or a set of genes from a next generation sequencing reaction can be used.

In some cases, a training sample or a training set of samples is used to determine the baseline ratio values for those situations that lack a copy number variation. For example, a cell or tissue sample known to have CYP2D6 and CYP2D7 genes that are not duplicated, multiplied, or deleted can be used as a training sample to determine baseline ratio values when assessing CYP2D6 and CYP2D7 genes for a copy number variation. In some cases, the training set can include at least two different samples (e.g., from two to 10,000 samples, from five to 10,000 samples, from ten to 10,000 samples, from 50 to 10,000 samples, from 100 to 10,000 samples, from 10 to 1,000 samples, or from 20 to 5,000 samples) known to lack copy number variations in the region of interest and the comparison region of interest. In some cases, a larger number of samples will result in a better confidence interval.

Once this baseline is determined, the ratio values of a sample being assessed can be compared to those baseline values to determine if a region of interest lacks a copy number variation or contains any type of copy number variation such as a duplication, multiplication, or deletion within the region of interest.

In some cases, the baseline ratio values can be determined by (a) obtaining average read depth values of next generation sequencing data for a plurality of sub-regions (e.g., exons) of a genetic region (e.g., a gene such as CYP2D6) for a set of training samples known to lack duplications, multiplications, and deletions in that genetic region, and (b) obtaining average read depth values from that same next generation sequencing data for a plurality of sub-regions (e.g., exons) of a comparison region (e.g., a gene such as CYP2D7) for that set of training samples. Each of the plurality of sub-regions of the genetic region can be comparable to one of the plurality of sub-regions of the comparison region. For example, exon 1 of the genetic region can be a sub-region that is comparable to exon 1 of the comparison region.

In some cases, a parameter other than an average read depth value can be used. For example, modal read depth values, maximum read depth values, minimum read depth values, 25^{th} percentile read depth values, or any other appropriate read depth value can be used in place of an average read depth.

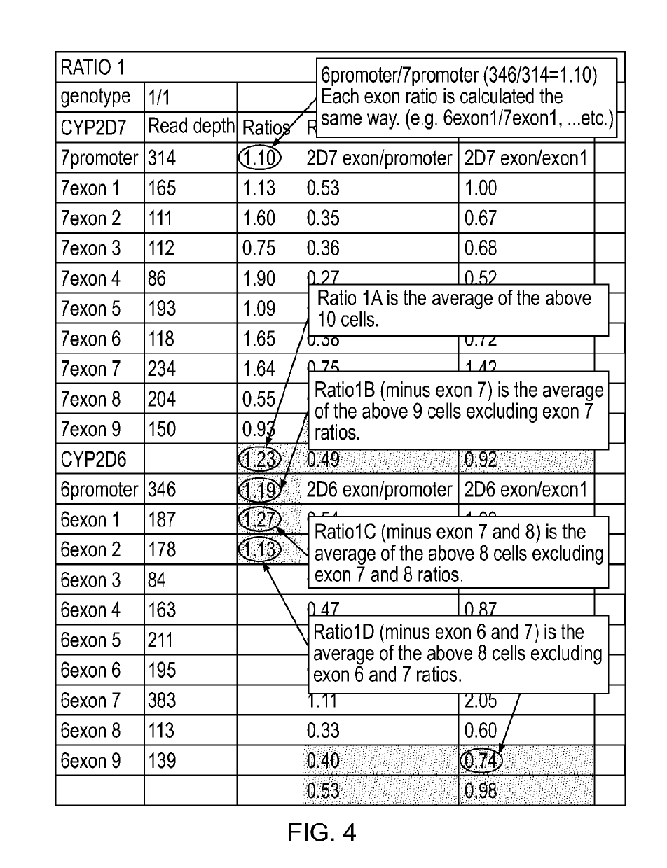

Once these average read depth values are obtained, the ratio of (i) the average read depth value for each of the plurality of sub-regions of the genetic region to (ii) the average read depth value for its comparable sub-region of the comparison region can be calculated to obtain a first set of ratios. The average for this first set of ratios can be calculated to obtain a Ratio 1 value (see, e.g., FIG. 4).

In some cases, the Ratio 1 value can be the average determined from all the first set of ratios or a portion of the first set of ratios. For example, as shown in FIG. 4, the Ratio 1 value can be determined from all the first set of ratios and designated a Ratio 1A value. In some cases, as shown in FIG. 4, the Ratio 1 value can be determined from less than all the first set of ratios (see, e.g., a Ratio 1B value, a Ratio 1C value, and a Ratio 1D value).

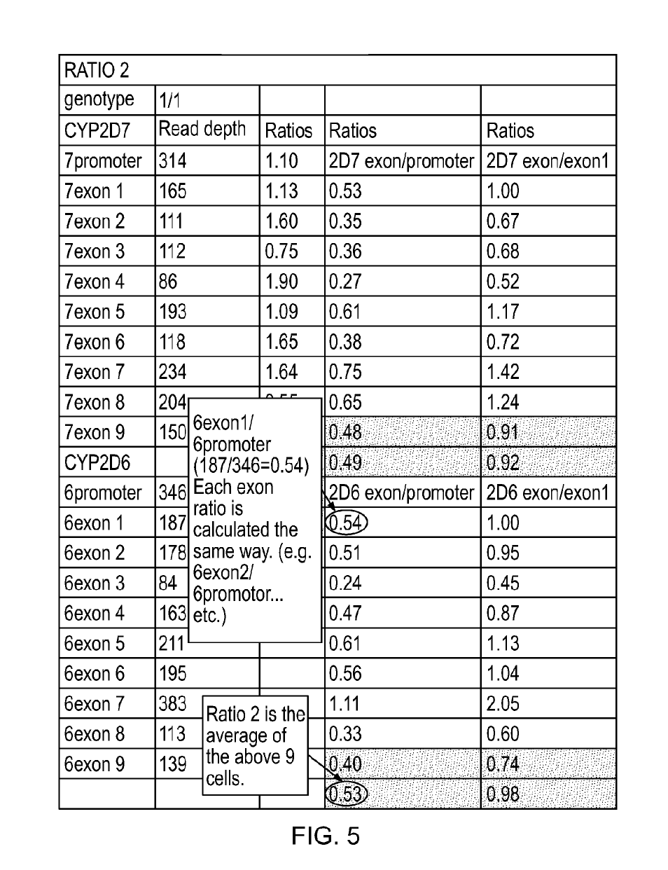

After obtaining a Ratio 1 value, one of the plurality of sub-regions of the genetic region can be selected to be a first selected sub-region. The other sub-regions of the genetic region can be designated as unselected sub-regions. At this point, the ratio of (i) the average read depth value for each of the unselected sub-regions to (ii) the average read depth value for the first selected sub-region can be calculated to obtain a second set of ratios. The average for the second set of ratios can be calculated to obtain a Ratio 2 value (see, e.g., FIG. 5).

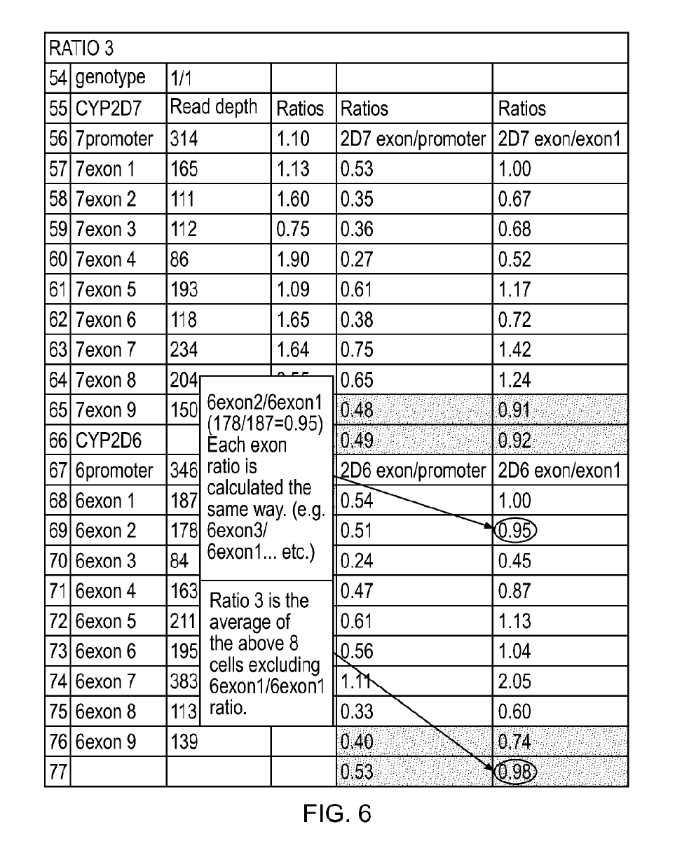

In some cases, a second one of the plurality of sub-regions of the genetic region can be selected to be a second selected sub-region. In these cases, the other sub-regions of the genetic region minus the first selected sub-region can be designated twice unselected sub-regions. At this point, the ratio of (i) the average read depth value for each of the twice unselected sub-regions to (ii) the average read depth value for the second selected sub-region can be calculated to obtain a third set of ratios. The average for the third set of ratios can be calculated to obtain a Ratio 3 value (see, e.g., FIG. 6).

This type of approach used to calculate Ratio 2 and Ratio 3 values can be repeated many times by selecting a third, fourth, five, and so on sub-region of the genetic region to calculate a Ratio 2/3′ value, a Ratio 2/3″ value, a Ratio 2/3′″ value and so on.

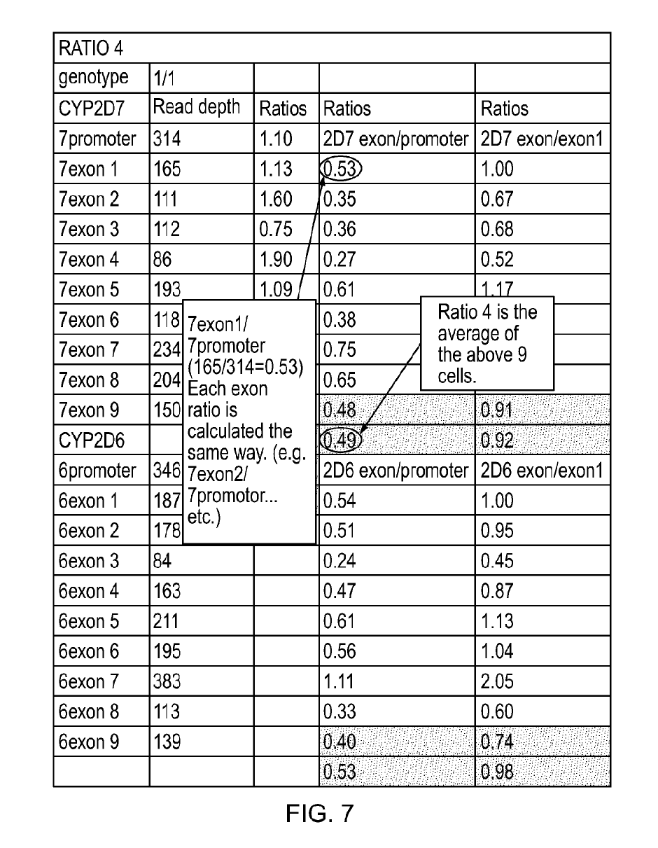

One of the plurality of sub-regions of the comparison region can be selected to be a first selected comparable sub-region. The other sub-regions of the comparison region can be designated as unselected comparison sub-regions. In some cases, the first selected comparable sub-region can be comparable to the first selected sub-region of the genetic region of interest. At this point, the ratio of (i) the average read depth value for each of the unselected comparison sub-regions to (ii) the average read depth value for the first selected comparable sub-region can be calculated to obtain a fourth set of ratios. The average for the fourth set of ratios can be calculated to obtain a Ratio 4 value (see, e.g., FIG. 7).

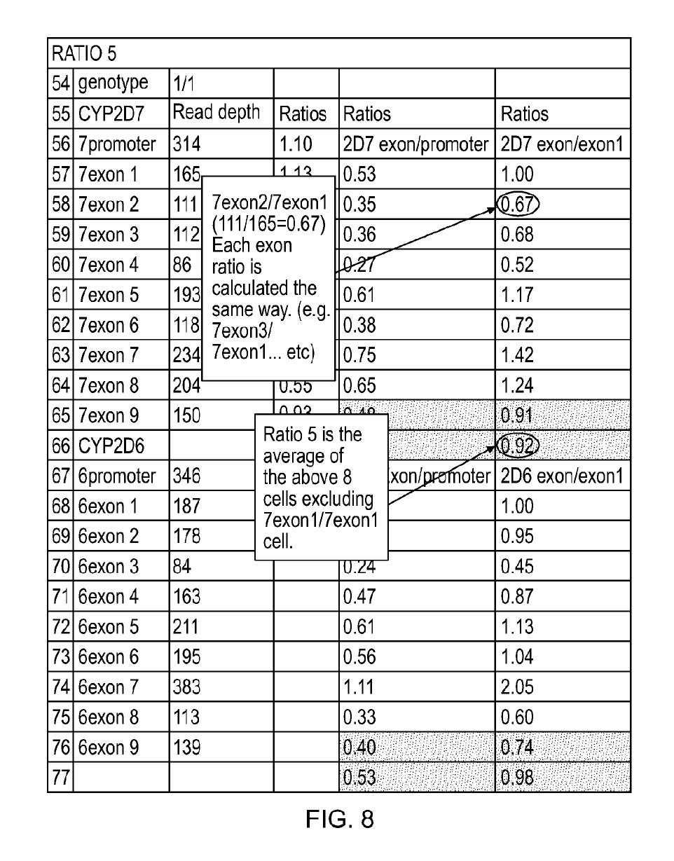

In some cases, a second one of the plurality of sub-regions of the comparison region can be selected to be a second selected comparable sub-region. In these cases, the other sub-regions of the comparison region minus the first selected comparable sub-region can be designated as twice unselected comparison sub-regions. At this point, the ratio of (i) the average read depth value for each of the twice unselected comparison sub-regions to (ii) the average read depth value for the second selected comparable sub-region can be calculated to obtain a fifth set of ratios. The average for the fifth set of ratios can be calculated to obtain a Ratio 5 value (see, e.g., FIG. 8).

This type of approach used to calculate Ratio 4 and Ratio 5 values can be repeated many times by selecting a third, fourth, five, and so on sub-region of the comparison region to calculate a Ratio 4/5′ value, a Ratio 4/5″ value, a Ratio 4/5′″ value and so on.

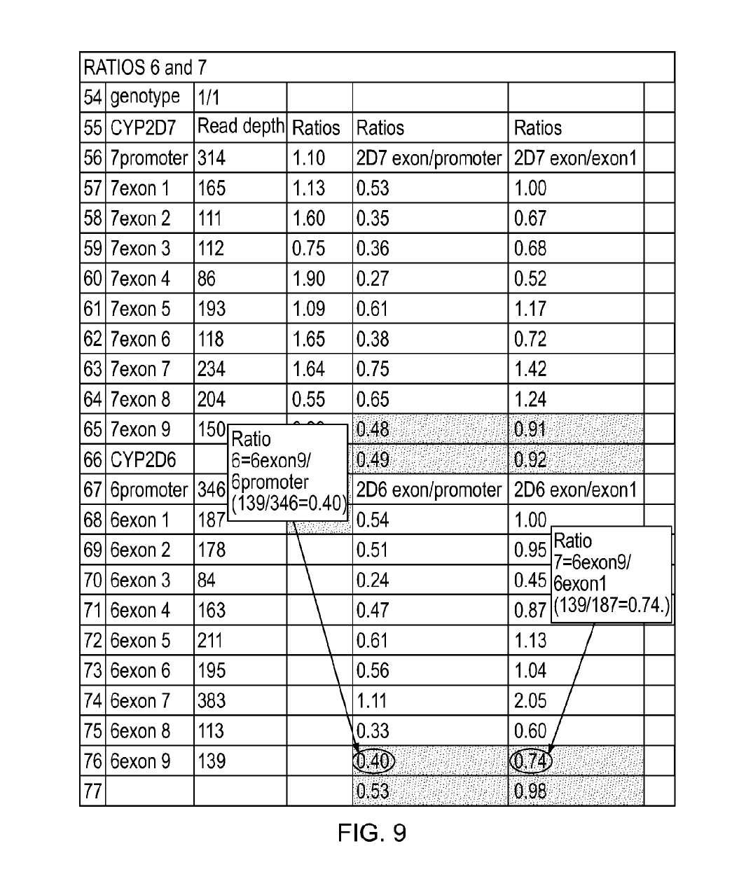

At this point, the ratio of (i) the average read depth value for one selection of the plurality of sub-regions of the genetic region to (ii) the average read depth value for another selection of the plurality of sub-regions of the genetic region can be calculated to obtain a Ratio 6 value (see, e.g., FIG. 9). In some cases, the ratio of (i) the average read depth value for one selection of the plurality of sub-regions of the genetic region to (ii) the average read depth value for another selection of the plurality of sub-regions of the genetic region can be calculated to obtain a Ratio 7 value (see, e.g., FIG. 9). In these cases, at least one of the one selection or the another selection used to obtain the Ratio 7 value can be different from the one selection and the another selection used to obtain the Ratio 6 value.

This type of approach used to calculate Ratio 6 and Ratio 7 values can be repeated many times by selecting different combinations of sub-regions of the genetic region to calculate a Ratio 6/7′ value, a Ratio 6/7″ value, a Ratio 6/7′″ value and so on.

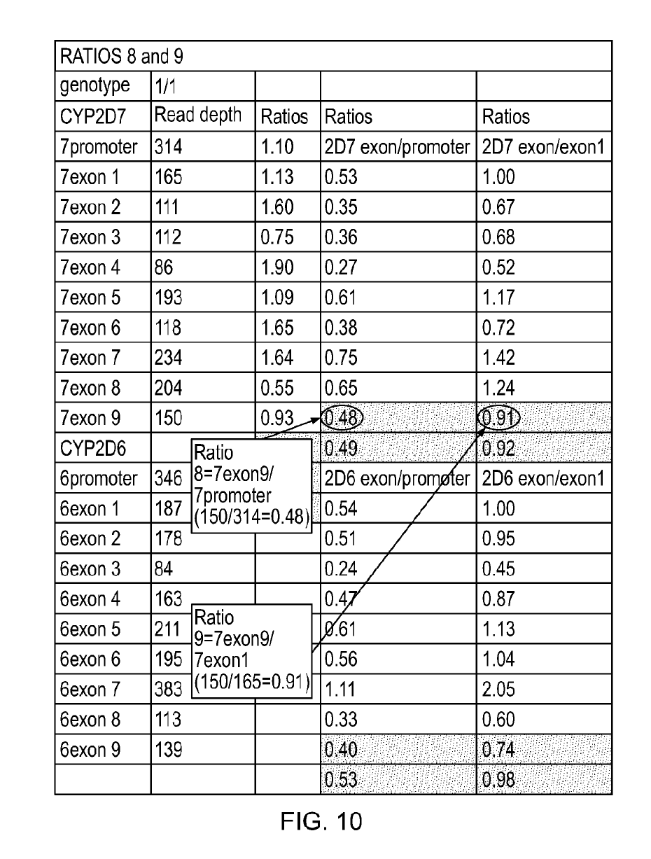

The ratio of (i) the average read depth value for one selection of the plurality of sub-regions of the comparison region to (ii) the average read depth value for another selection of the plurality of sub-regions of the comparison region can be calculated to obtain a Ratio 8 value (see, e.g., FIG. 10). In some cases, the ratio of (i) the average read depth value for one selection of the plurality of sub-regions of the comparison region to (ii) the average read depth value for another selection of the plurality of sub-regions of the comparison region can be calculated to obtain a Ratio 9 value (see, e.g., FIG. 10). In these cases, at least one of the one selection or the another selection used to obtain the Ratio 8 value can be different from the one selection and the another selection used to obtain the Ratio 9 value.

This type of approach used to calculate Ratio 8 and Ratio 9 values can be repeated many times by selecting different combinations of sub-regions of the comparison region to calculate a Ratio 8/9′ value, a Ratio 8/9″ value, a Ratio 8/9′″ value and so on.

The ratio values or a portion of the ratio values determined for a training sample or a set of training samples can be used to determine a baseline indicative of a lack of copy number variation. For example, the Ratio 1-9 values, or a portion of them (e.g., Ratio 1-6 and 8 values), can be used to determine a baseline indicative of a lack of copy number variation. In some cases, at least three, four, five, six, seven, eight, nine, ten, eleven, or more ratio values determined for a training sample or a set of training samples can be used to determine a baseline indicative of a lack of copy number variation. Such ratio values determined for a training sample or a set of training samples can include Ratio 1-9, 1A, 1B, 1C, 1D, 2/3′, 2/3″, 2/3′″, 4/5′, 4/5″, 4/5′″, 6/7′, 6/7″, 6/7′″, 8/9′, 8/9″, 8/9′″, and so on. In some cases, any appropriate standard deviation (e.g., 1.8, 2, 2.1, 2.5, 2.9, 3, 3.1, 3.5, 3.9 or 4 standard deviations) from mean Ratio values can be used as a cut off for detecting the presence of a copy number variation.

Once this baseline of ratio values or a portion of the ratio values determined for a training sample or a set of training samples (e.g., Ratio 1-9 values) is obtained, the comparable ratio values for a sample being analyzed (e.g., Ratio 1-9 values) can be compared to that baseline to detect the presence of a copy number variation (e.g., a duplication, multiplication, or deletion). The comparable ratio values (e.g., Ratio 1-9 values) of a sample being analyzed can be obtained using the same calculations used to obtain the ratio values (e.g., Ratio 1-9 values) of the baseline. In some cases, the baseline determinations and the ratio value determinations for the sample being analyzed are all based on next generation sequencing data obtained from the same next generation sequencing platform (e.g., Illumina or Pacific Biosciences next generation sequencing). In some cases, the baseline determinations and the ratio value determinations for the sample being analyzed are all based on next generation sequencing data obtained from the same run of a particular next generation sequencing procedure.

The invention will be further described in the following examples, which do not limit the scope of the invention described in the claims.

### EXAMPLES

### Example 1—Detecting Copy Number Variations

A method was developed by which copy number variations are predicted from next generation sequencing results. The cytochrome P450 2D6 (CYP2D6) gene, which is a gene that can be duplicated, multiplied, or deleted and can form hybrid genes with its pseudogene called CYP2D7, was used as an example. Accurate and rapid analysis of this gene locus can be important for determining the phenotype of an individual who is being genotyped for pharmacogenomic purposes.

This method involved determining average sequencing read depth of a specific genomic region of interest and comparing it to average read depth of another region of interest. Standardization for a particular platform was completed using samples with known genotypes and CYP2D loci structures, which are collectively referred to as the training set. In some cases, this standardization can be performed within a given sample, thereby eliminating the need for a training set. In this example, a training set was used.

In the case of CYP2D6, regions of interest (ROI) included 1-1000 nucleotides upstream of the start codon (called the promoter region) and all or part of the nine CYP2D6 exons (Table 2). For each ROI, average read depth was determined by any appropriate technique. In this example, a program (Alamut Visual, version 2.6.0, Interactive Biosoftware, Rouen, France) was used to calculate ROI average read depth from a series of data generated from a pharmacogenomic panel that included CYP2D6 capture (manufactured by Roche NimbleGen Inc.; Madison, Wis.). Average read depths were generated for the corresponding regions of CYP2D7 (Table 3).

TABLE 2
Positions of CYP2D6 promoter and its nine
exons according to genome build grch37.

| Chromosome | End | Start |
|---|---|---|
| chr22 (Promotor) | 42526884 | 42527884 |
| chr22 (Exon 1) | 42526614 | 42526883 |
| chr22 (Exon 2) | 42525740 | 42525911 |
| chr22 (Exon 3) | 42525035 | 42525187 |
| chr22 (Exon 4) | 42524786 | 42524946 |
| chr22 (Exon 5) | 42524176 | 42524352 |
| chr22 (Exon 6) | 42523844 | 42523985 |
| chr22 (Exon 7) | 42523449 | 42523636 |
| chr22 (Exon 8) | 42522853 | 42522994 |
| chr22 (Exon 9) | 42522501 | 42522754 |

TABLE 3
Positions of CYP2D7 promoter and its nine
exons according to genome build grch37.

| chromosome | start | end |
|---|---|---|
| chr22 | 42540577 | 42541577 |
| chr22 | 42540285 | 42540575 |
| chr22 | 42539411 | 42539582 |
| chr22 | 42538729 | 42538881 |
| chr22 | 42538480 | 42538640 |
| chr22 | 42537878 | 42538054 |
| chr22 | 42537544 | 42537685 |
| chr22 | 42537162 | 42537349 |
| chr22 | 42536566 | 42536707 |
| chr22 | 42536214 | 42536467 |

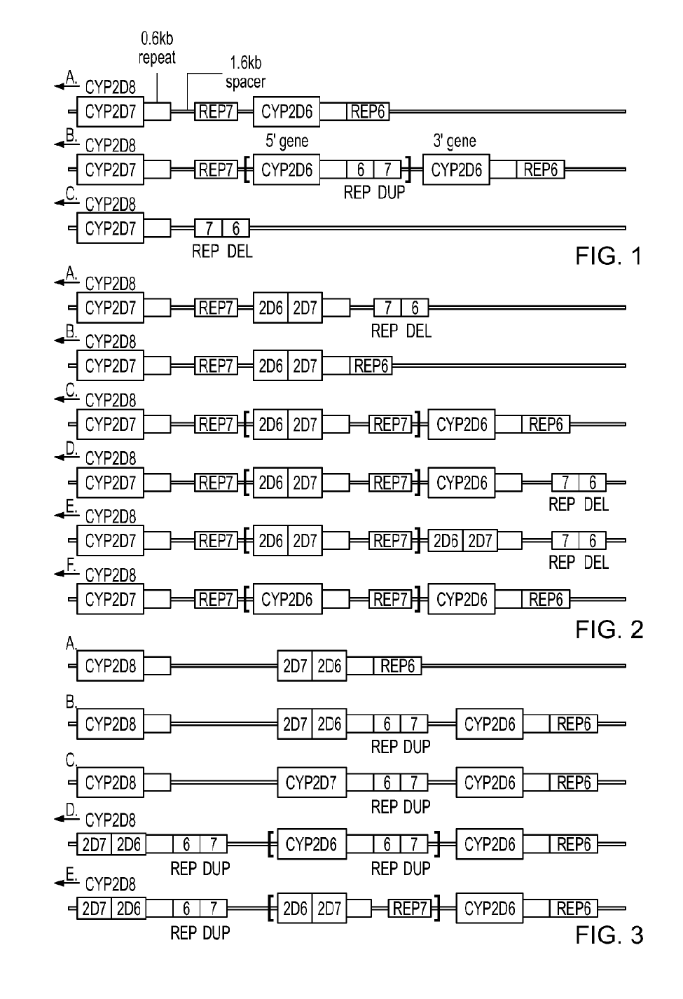

Comparisons between CYP2D6 and CYP2D7 average read depths and between various regions within CYP2D6 and CYP2D7 intragenically were done within the same sample sequenced at the same time. A ratio of ROIs was calculated for each sample in the training set as follows. The average read depth for the CYP2D6 and CYP2D7 promoter and each exon was determined for each sample in the training set. Generally, the training set included samples having only two copies of CYP2D6 and only two copies of CYP2D7 (FIG. 1A).

For the ratio 1 series, the CYP2D6 promoter average read depth was divided by the CYP2D7 promoter average read depth to obtain a value of 1.10 (FIG. 4). The same was done for each exon by dividing the specific CYP2D6 exon average read depth by the corresponding CYP2D7 exon average read depth (FIG. 4). These ten ratios (ratio 1 series) were then averaged together (Ratio 1A; FIG. 4). Because of homology between CYP2D6 and CYP2D7 for exons 6, 7, and 8, additional average ratios were generated without exon 7 data (Ratio 1B; FIG. 4), without exons 7 and 8 data (Ratio 1C; FIG. 4), and without exons 6 and 7 (Ratio 1D; FIG. 4). The Ratio 1B, Ratio 1C, and Ratio 1D were used to increase the sensitivity of the ratios to detect copy number variations.

For the ratio 2 series, for each sample, the CYP2D6 exons 1-9 average read depths were divided by the CYP2D6 promoter average read depth individually (FIG. 5). These nine ratios were then averaged for obtain Ratio 2 (FIG. 5).

For the ratio 3 series, for each sample, the CYP2D6 exon 2-9 average read depths were divided by the CYP2D6 exon 1 average read depth individually (FIG. 6). These eight ratios were then averaged to obtain Ratio 3 (FIG. 6).

For the ratio 4 series, for each sample, the CYP2D7 exons 1-9 average read depths were divided by the CYP2D7 promoter average read depth individually (FIG. 7). These nine ratios were then averaged to obtain Ratio 4 (FIG. 7).

For the ratio 5 series, for each sample, the CYP2D7 exon 2-9 average read depths were divided by the CYP2D7 exon 1 average read depth individually (FIG. 8). These eight ratios were then averaged to obtain Ratio 5 (FIG. 8).

For Ratio 6, for each sample, the average CYP2D6 exon 9 read depth was divided by the CYP2D6 promoter average read depth to obtain Ratio 6 (FIG. 9). For Ratio 7, for each sample, the CYP2D6 exon 9 average read depth was divided by the CYP2D6 exon 1 average read depth to obtain Ratio 7 (FIG. 9).

For Ratio 8, for each sample, the average CYP2D7 exon 9 read depth was divided by the CYP2D7 promoter average read depth to obtain Ratio 8 (FIG. 10). For Ratio 9, for each sample, the CYP2D7 exon 9 average read depth was divided by the CYP2D7 exon 1 average read depth to obtain Ratio 9 (FIG. 10).

For training set analysis, samples with a locus with a normal CYP2D arrangement (e.g., FIG. 1A) were used to calculate the ratios. Any number of samples can be in the training set, but the larger the training set the better the calculated confidence interval. 45 sample were used to generate the data shown in FIGS. 4-10.

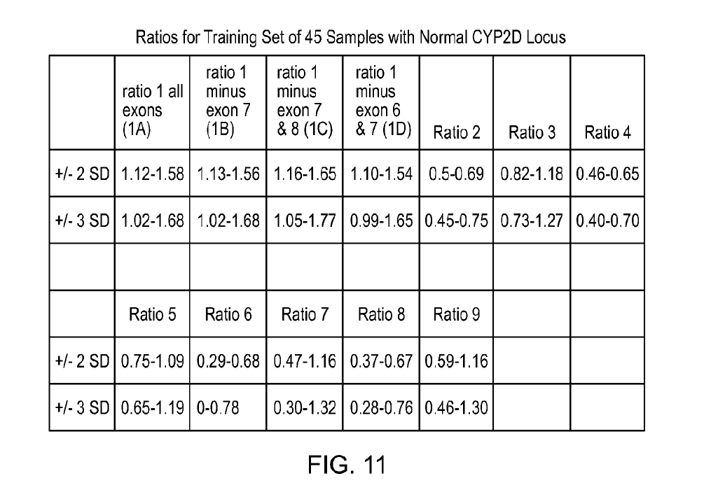

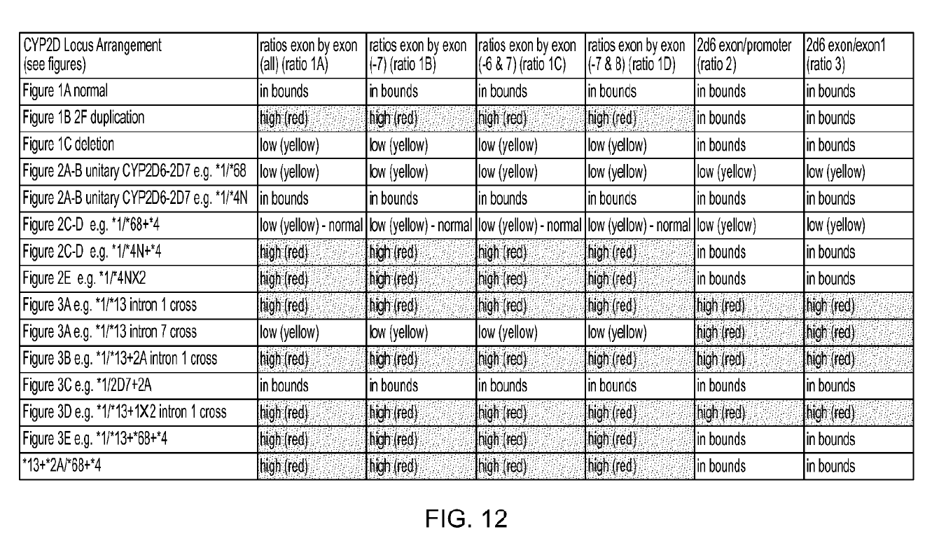

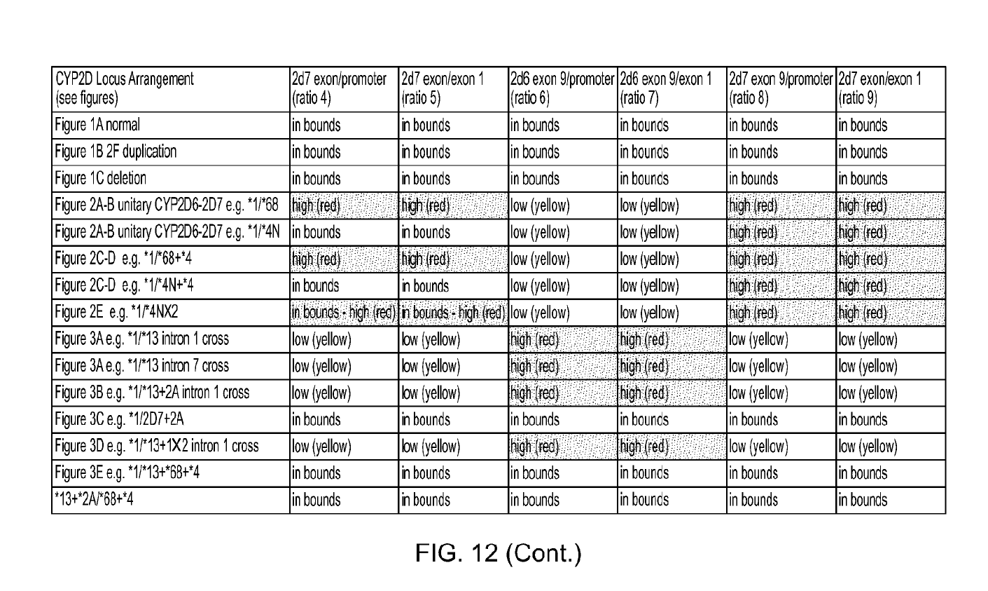

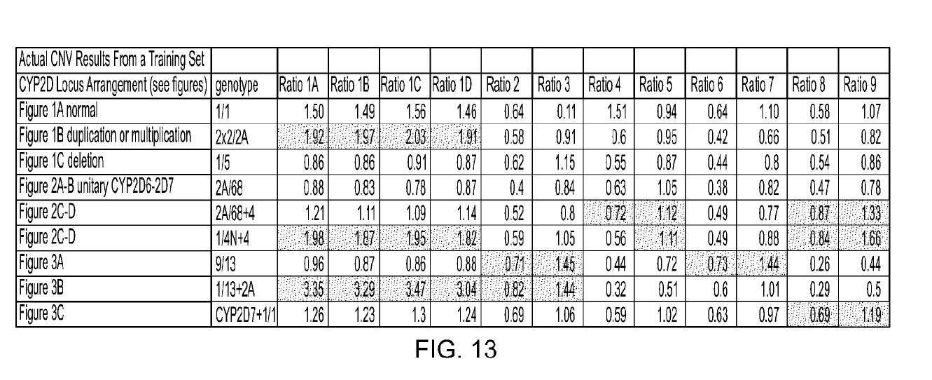

Each of the ratios for these normal (FIG. 1A) CYP2D loci structures were treated statistically to generate averages and standard deviations (FIG. 11). These averages+/−two standard deviations or +/−three standard deviations were used to determine confidence intervals (CI). These confidence intervals were used to determine the CYP2D locus structure for unknown clinical or research samples. FIG. 11 shows the results of a training set of 45 samples analyzed for CYP2D locus. FIG. 12 shows the expected results for CYP2D locus analysis.

Variations in reagent capture caused by polymorphisms present in an individual sample or caused by sequence homology between a gene (e.g., CYP2D6) and its pseudogene(s) (e.g., CYP2D7) may cause samples to yield results that vary from the model, but the presence of any ratio deviations should cause concern that the CYP2D locus is altered in a given sample. Examples of results obtained for various CYP2D locus types are shown in FIG. 13. Samples falling outside of the training set CI can be further analyzed to determine the exact CYP2D locus structure as described elsewhere (Black et al., Drug Metabolism and Deposition, 40:111-119 (2012) and Kramer et al., Pharmacogenomics and Genetics, 19:813-822 (2009)).

The methods and materials described herein were not dependent upon the presence of a pseudogene. In those cases where a pseudogene does not exist, another gene not prone to duplication, multiplication, or deletion that is captured by the capture reagent for the sequencing platform in use (where a capture is used; or simply sequenced when using those next generation sequencing platforms that do not use a capture reagent) can be used as the comparison gene, and exons can be selected for comparison at the user's discretion. In some cases, read depth data (e.g., average read depth values) from the entire sequencing reaction can be used (e.g., average, modal, minimum, or maximum read depth data for the entire or any part of the sequencing method in use can be used).

The results provided herein demonstrate that combinations of ratio determinations can be used to determine copy number variations for any appropriate gene loci including those known to have complicated structures (e.g., the CYP2D6-CYP2D7 locus).

### Example 2—Using SNPs to Identify CYP2D6*2 and CYP2D6*1 Duplications

The following tagging SNP strategy was developed for determining CYP2D6*2 (not *2A) and CYP2D6*1 duplications. For CYP2D loci containing a duplicated CYP2D6*2 allele other than CYP2D6*2A allele, any or all of the following polymorphisms were used to identify the presence of a duplicated CYP2D6*2 allele:

A. Chr22(GRCh37):g.42525438A>G (aka NM_000106.4 (CYP2D6):c.353-251T>C) rs184086520

B. Chr22(GRCh37):g.42525305T>G (aka NM_000106.4 (CYP2D6):c.353-118A>C) rs142302759

C. Chr22(GRCh37):g.42524132C>T (aka NM_000106.4 (CYP2D6):c.843+44G>A) rs76015180.

Presence of these variations with the duplicated CYP2D6*2 allele approached 100%. The presence of one or all of these variations strongly suggests the presence of a CYP2D6*2 duplication. For CYP2D loci containing a duplicated CYP2D6*1 allele, any of the following polymorphisms were used to identify the presence of a duplicated CYP2D6*1 allele:

A. Chr22(GRCh37):g.42525952C>A (aka NM_000106.4 (CYP2D6):c.181-41G>T rs28371702

B. Chr22(GRCh37):g.42525625C>T (aka NM_000106.4 (CYP2D6):c.352+115G>A rs1081004.

rs28371702 was associated with 10% of CYP2D6*1 duplications, and rs1081004 was associated with 50% of CYP2D6*1 duplications. rs28371702 was seen only once and in associate with rs1081004 in the duplicated allele. The presence of these variations on a CYP2D6*1 background suggests a duplication is present.

### Example 3—Calling Copy Number Variations (CNVs)

The National Institutes of Health's Pharmacogenomics Research Network (PGRN) developed a Next Generation Sequencing (NGS) Kit, PGRN-Seqv2. PGRN-Seqv2 is a custom capture reagent of pharmacogenes with strong drug phenotype associations. Sequence captured included the entire CYP2D7 and CYP2D6 genes with capture in the promoter region to make calls involving the −1584C>G variant. Historically, 1013 samples from the Mayo Clinic RIGHT protocol and eMERGE grant (NIH# HG006379), which used a previous version of PGRN-Seq called v1, were analyzed in a CLIA/CAP/NYS qualified clinical laboratory and the results of this genetic testing for selected genes were placed in the electronic medical record for clinical use. At the time that the RIGHT/eMERGE testing was done, CYP2D6 could not be analyzed on NGS data so testing was done on all 1013 samples using the Luminex xTAG Kit for CYP2D6 version 2, which evaluates samples for duplications and/or deletions alleles such as (*5), *2A, *2-*4, *6-*12, *14, *15, *17, and *41 alleles.

When sample results met certain criteria (e.g., duplication present and other indications), they were further evaluated to determine CNV and true diplotype by real time PCR and Sanger sequencing (this is called the CYP2D6 clinical cascade testing). Therefore, the CYP2D6 clinical testing cascade was done as needed to eliminate ambiguity in diplotype calls and phenotype. A training set with known CYP2D6 CNVs was used to build the method provided herein wherein copy number variations are predicted from next generation sequencing results.

Subsequently, 494 of the 1013 samples were analyzed using the PGRN-Seqv2 reagent in a blinded fashion (i.e., results of previous testing were not known to the operator) using the method provided herein wherein copy number variations are predicted from next generation sequencing results. The method confirmed copy number variations in the 42 “control” samples that had been fully analyzed using the CYP2D6 clinical cascade as part of the original eMERGE grant noted above. In addition, 58 additional samples with CNV were identified from the 494 samples. The new CNV findings were confirmed using the CYP2D6 clinical cascade as described above. Therefore, the results of the method provided herein wherein copy number variations are predicted from next generation sequencing results were concordant with the existing clinical assay for these 58 samples. CNVs included *5 (CYP2D6 deletions), CYP2D6 duplications and multiplications, CYP2D6-2D7 hybrids such as *4N, *36 and *68 in both unitary and tandem hybrid configurations as well as CYP2D7-2D6 hybrids such as *13 in both unitary and tandem hybrid configurations. In 17 instances (including the control samples), the phenotype was changed as a result of this information and in every case the diplotype for these samples changed. No spurious CNV calls were made by the method provided herein wherein copy number variations are predicted from next generation sequencing results.

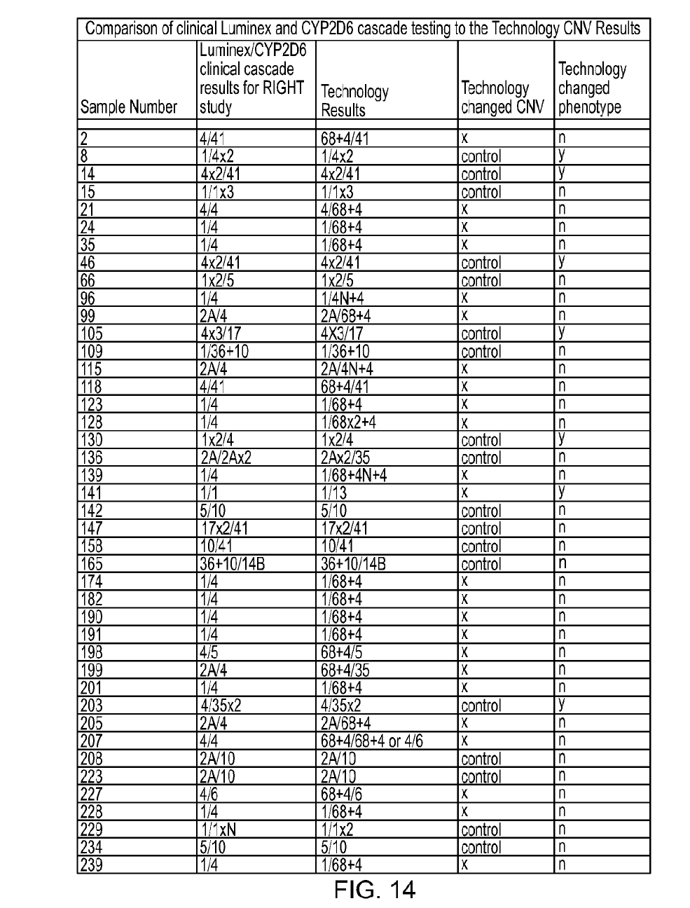

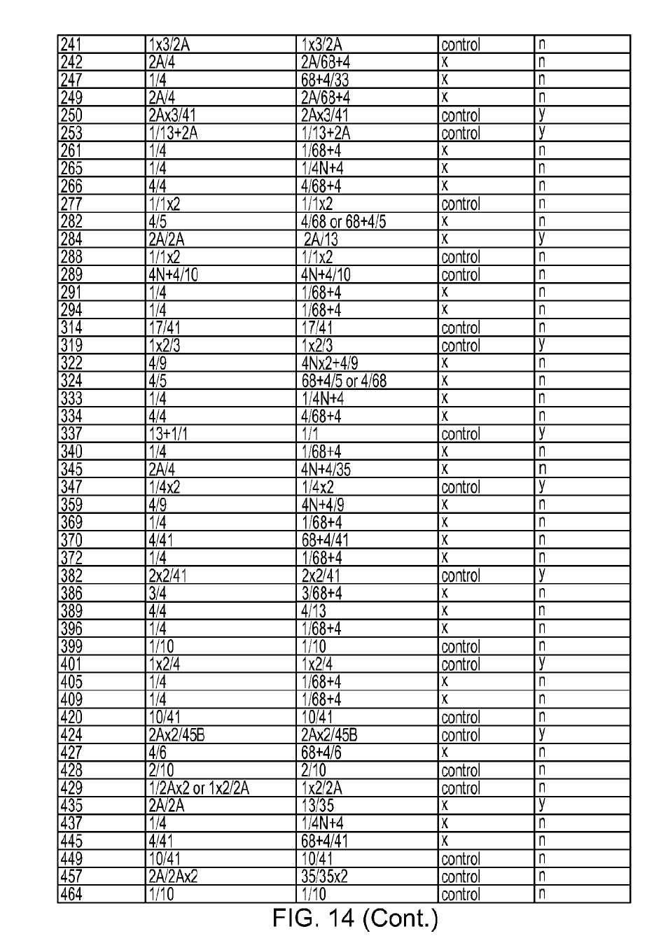

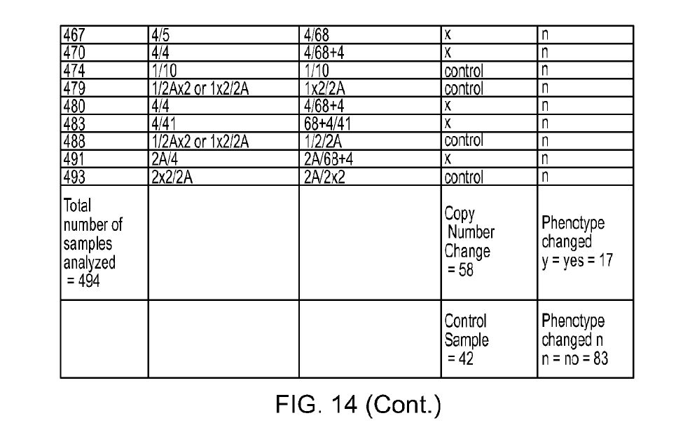

Comparison of clinical Luminex and CYP2D6 cascade testing to the method provided herein wherein copy number variations are predicted from next generation sequencing (the “Technology”) was shown in FIG. 14. FIG. 14 compares the results of CYP2D6 Luminex testing and CYP2D6 clinical cascade testing to the “Technology.” Only the samples with identified CNV changes are shown. In the “Technology changed CNV” column, ‘x’ means that a CNV change was detected and ‘control’ means that these were samples from the RIGHT/eMERGE study that had the CYP2D6 clinical Cascade testing done. In the “Technology changed phenotype” column, ‘n’ means no and ‘y’ means yes; the phenotype was changed as a result of use of the “Technology.” In some instances, *2A alleles were changed to “*35” alleles as a result of other different testing that was done.

These results demonstrated that the method provided herein wherein copy number variations are predicted from next generation sequencing results allowed for 100% correct CNV calls in the 494 samples such that the 42 control samples were correctly analyzed and 58 new samples with CNVs were correctly identified. These analyses changed phenotype for 17 individuals and changed the genotype for all samples.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of detecting the presence of a genetic duplication, multiplication, or deletion in a genetic region of interest of a sample, wherein said method comprises:
(a) obtaining average read depth values of next generation sequencing data for a plurality of sub-regions of said genetic region for a set of training samples known to lack said duplication, multiplication, or deletion,
(b) obtaining average read depth values of said next generation sequencing data for a plurality of sub-regions of a comparison region for said set of training samples, wherein said genetic region is comparable to said comparison region, and wherein each of said plurality of sub-regions of said genetic region is comparable to one of said plurality of sub-regions of said comparison region,
(c) optionally calculating the ratio of (i) said average read depth value for each of said plurality of sub-regions of said genetic region to (ii) said average read depth value for its comparable sub-region of said comparison region to obtain a first set of ratios,
(d) optionally calculating the average for said first set of ratios to obtain a Ratio 1 value,
(e) optionally selecting one of said plurality of sub-regions of said genetic region to be a first selected sub-region, wherein the other sub-regions of said genetic region are unselected sub-regions,
(f) optionally calculating the ratio of (i) said average read depth value for each of said unselected sub-regions to (ii) said average read depth value for said first selected sub-region to obtain a second set of ratios,
(g) optionally calculating the average for said second set of ratios to obtain a Ratio 2 value,
(h) optionally selecting a second one of said plurality of sub-regions of said genetic region to be a second selected sub-region, wherein the other sub-regions of said genetic region minus said first selected sub-region are twice unselected sub-regions,
(i) optionally calculating the ratio of (i) said average read depth value for each of said twice unselected sub-regions to (ii) said average read depth value for said second selected sub-region to obtain a third set of ratios,
(j) optionally calculating the average for said third set of ratios to obtain a Ratio 3 value,
(k) optionally selecting one of said plurality of sub-regions of said comparison region to be a first selected comparable sub-region, wherein the other sub-regions of said comparison region are unselected comparison sub-regions, and wherein said first selected comparable sub-region is comparable to said first selected sub-region,
(l) optionally calculating the ratio of (i) said average read depth value for each of said unselected comparison sub-regions to (ii) said average read depth value for said first selected comparable sub-region to obtain a fourth set of ratios,
(m) optionally calculating the average for said fourth set of ratios to obtain a Ratio 4 value,
(n) optionally selecting a second one of said plurality of sub-regions of said comparison region to be a second selected comparable sub-region, wherein the other sub-regions of said comparison region minus said first selected comparable sub-region are twice unselected comparison sub-regions,
(o) optionally calculating the ratio of (i) said average read depth value for each of said twice unselected comparison sub-regions to (ii) said average read depth value for said second selected comparable sub-region to obtain a fifth set of ratios,
(p) optionally calculating the average for said fifth set of ratios to obtain a Ratio 5 value,
(q) optionally calculating the ratio of (i) said average read depth value for one selection of said plurality of sub-regions of said genetic region to (ii) said average read depth value for another selection of said plurality of sub-regions of said genetic region to obtain a Ratio 6 value,
(r) optionally calculating the ratio of (i) said average read depth value for one selection of said plurality of sub-regions of said genetic region to (ii) said average read depth value for another selection of said plurality of sub-regions of said genetic region to obtain a Ratio 7 value, wherein at least one of said one selection or said another selection of step (r) is different from said one selection and said another selection of step (q),
(s) optionally calculating the ratio of (i) said average read depth value for one selection of said plurality of sub-regions of said comparison region to (ii) said average read depth value for another selection of said plurality of sub-regions of said comparison region to obtain a Ratio 8 value,
(t) optionally calculating the ratio of (i) said average read depth value for one selection of said plurality of sub-regions of said comparison region to (ii) said average read depth value for another selection of said plurality of sub-regions of said comparison region to obtain a Ratio 9 value, wherein at least one of said one selection or said another selection of step (t) is different from said one selection and said another selection of step (s),
wherein at least three sets of optional steps selected from the group consisting of said steps (c)-(d), (e)-(g), (h)-(j), (k)-(m), (n)-(p), (q), (r), (s), and (t) are performed to obtain at least three training set ratio values selected from the group consisting of said Ratio 1 value, said Ratio 2 value, said Ratio 2 value, said Ratio 4 value, said Ratio 5 value, said Ratio 6 value, said Ratio 7 value, said Ratio 8 value, and said Ratio 9 value, respectively,
(u) obtaining at least three ratio values for said sample that are comparable to said at least three training set ratio values selected from said group consisting of said Ratio 1 value, said Ratio 2 value, said Ratio 2 value, said Ratio 4 value, said Ratio 5 value, said Ratio 6 value, said Ratio 7 value, said Ratio 8 value, and said Ratio 9 value, and
(v) comparing said at least three comparable ratio values for said sample obtained in step (u) to said at least three training set ratio values to identify the presence of said duplication, multiplication, or deletion.

2. The method of claim 1, wherein said genetic region of interest is a CYP2D6 locus.

3. The method of claim 1, wherein said plurality of sub-regions of said genetic region are a plurality of exons.

4. The method of claim 1, wherein at least one of said plurality of sub-regions of said genetic region is a promoter region.

5. The method of claim 1, wherein said comparison region of interest is a CYP2D7 locus.

6. The method of claim 1, wherein said plurality of sub-regions of said comparison region are a plurality of exons.

7. The method of claim 1, wherein at least one of said plurality of sub-regions of said comparison region is a promoter region.

8. The method of claim 1, wherein next generation sequencing data is data from next generation sequencing comprising clonal bridge amplification for template preparation and reversible dye terminators.

9. The method of claim 1, wherein next generation sequencing data is data from next generation sequencing comprising clonal-emPCR for template preparation and pyrosequencing.

10. The method of claim 1, wherein next generation sequencing data is data from next generation sequencing comprising clonal-emPCR for template preparation, and oligonucleotide chained ligation or proton detection.

11. The method of claim 1, wherein next generation sequencing data is data from next generation sequencing comprising using phospholinked fluorescent nucleotides.

12-17. (canceled)

18. The method of claim 1, wherein said method comprises performing at least seven sets of optional steps selected from the group consisting of said steps (c)-(d), (e)-(g), (h)-(j), (k)-(m), (n)-(p), (q), (r), (s), and (t) to obtain at least seven training set ratio values selected from the group consisting of said Ratio 1 value, said Ratio 2 value, said Ratio 2 value, said Ratio 4 value, said Ratio 5 value, said Ratio 6 value, said Ratio 7 value, said Ratio 8 value, and said Ratio 9 value, respectively.

19. The method of claim 18, wherein said method comprises:
(u2) obtaining at least seven ratio values for said sample that are comparable to said at least seven training set ratio values selected from said group consisting of said Ratio 1 value, said Ratio 2 value, said Ratio 2 value, said Ratio 4 value, said Ratio 5 value, said Ratio 6 value, said Ratio 7 value, said Ratio 8 value, and said Ratio 9 value, and
(v2) comparing said at least seven comparable ratio values for said sample obtained in step (u2) to said at least seven training set ratio values to identify the presence of said duplication, multiplication, or deletion.

20. The method of claim 1, wherein said method comprises performing at least eight sets of optional steps selected from the group consisting of said steps (c)-(d), (e)-(g), (h)-(j), (k)-(m), (n)-(p), (q), (r), (s), and (t) to obtain at least eight training set ratio values selected from the group consisting of said Ratio 1 value, said Ratio 2 value, said Ratio 2 value, said Ratio 4 value, said Ratio 5 value, said Ratio 6 value, said Ratio 7 value, said Ratio 8 value, and said Ratio 9 value, respectively.

21. The method of claim 20, wherein said method comprises:
(u2) obtaining at least eight ratio values for said sample that are comparable to said at least eight training set ratio values selected from said group consisting of said Ratio 1 value, said Ratio 2 value, said Ratio 2 value, said Ratio 4 value, said Ratio 5 value, said Ratio 6 value, said Ratio 7 value, said Ratio 8 value, and said Ratio 9 value, and
(v2) comparing said at least eight comparable ratio values for said sample obtained in step (u2) to said at least eight training set ratio values to identify the presence of said duplication, multiplication, or deletion.

22. A method of detecting the presence of a genetic duplication, multiplication, or deletion in a genetic region of interest of a sample, wherein said method comprises:
(a) obtaining average read depth values of next generation sequencing data for a plurality of sub-regions of said genetic region for a set of training samples known to lack said duplication, multiplication, or deletion,
(b) obtaining average read depth values of said next generation sequencing data for a plurality of sub-regions of a comparison region for said set of training samples, wherein said genetic region is comparable to said comparison region, and wherein each of said plurality of sub-regions of said genetic region is comparable to one of said plurality of sub-regions of said comparison region,
(c) calculating the ratio of (i) said average read depth value for each of said plurality of sub-regions of said genetic region to (ii) said average read depth value for its comparable sub-region of said comparison region to obtain a first set of ratios,
(d) calculating the average for said first set of ratios to obtain a Ratio 1 value,
(e) selecting one of said plurality of sub-regions of said genetic region to be a first selected sub-region, wherein the other sub-regions of said genetic region are unselected sub-regions,
(f) calculating the ratio of (i) said average read depth value for each of said unselected sub-regions to (ii) said average read depth value for said first selected sub-region to obtain a second set of ratios,
(g) calculating the average for said second set of ratios to obtain a Ratio 2 value,
(h) selecting a second one of said plurality of sub-regions of said genetic region to be a second selected sub-region, wherein the other sub-regions of said genetic region minus said first selected sub-region are twice unselected sub-regions,
(i) calculating the ratio of (i) said average read depth value for each of said twice unselected sub-regions to (ii) said average read depth value for said second selected sub-region to obtain a third set of ratios,
(j) calculating the average for said third set of ratios to obtain a Ratio 3 value,
(k) selecting one of said plurality of sub-regions of said comparison region to be a first selected comparable sub-region, wherein the other sub-regions of said comparison region are unselected comparison sub-regions, and wherein said first selected comparable sub-region is comparable to said first selected sub-region,
(l) calculating the ratio of (i) said average read depth value for each of said unselected comparison sub-regions to (ii) said average read depth value for said first selected comparable sub-region to obtain a fourth set of ratios,
(m) calculating the average for said fourth set of ratios to obtain a Ratio 4 value,
(n) selecting a second one of said plurality of sub-regions of said comparison region to be a second selected comparable sub-region, wherein the other sub-regions of said comparison region minus said first selected comparable sub-region are twice unselected comparison sub-regions,
(o) calculating the ratio of (i) said average read depth value for each of said twice unselected comparison sub-regions to (ii) said average read depth value for said second selected comparable sub-region to obtain a fifth set of ratios,
(p) calculating the average for said fifth set of ratios to obtain a Ratio 5 value,
(q) calculating the ratio of (i) said average read depth value for one selection of said plurality of sub-regions of said genetic region to (ii) said average read depth value for another selection of said plurality of sub-regions of said genetic region to obtain a Ratio 6 value,
(r) calculating the ratio of (i) said average read depth value for one selection of said plurality of sub-regions of said genetic region to (ii) said average read depth value for another selection of said plurality of sub-regions of said genetic region to obtain a Ratio 7 value, wherein at least one of said one selection or said another selection of step (r) is different from said one selection and said another selection of step (q),
(s) calculating the ratio of (i) said average read depth value for one selection of said plurality of sub-regions of said comparison region to (ii) said average read depth value for another selection of said plurality of sub-regions of said comparison region to obtain a Ratio 8 value,
(t) calculating the ratio of (i) said average read depth value for one selection of said plurality of sub-regions of said comparison region to (ii) said average read depth value for another selection of said plurality of sub-regions of said comparison region to obtain a Ratio 9 value, wherein at least one of said one selection or said another selection of step (t) is different from said one selection and said another selection of step (s),
(u) obtaining comparable Ratio 1-9 values for said sample, and
(v) comparing said comparable Ratio 1-9 values of said sample to said Ratio 1-9 values of said set of training samples to identify the presence of said duplication, multiplication, or deletion.

23. The method of claim 22, wherein said genetic region of interest is a CYP2D6 locus.

24. The method of claim 22, wherein said plurality of sub-regions of said genetic region are a plurality of exons.

25. The method of claim 22, wherein at least one of said plurality of sub-regions of said genetic region is a promoter region.

26. The method of claim 22, wherein said comparison region of interest is a CYP2D7 locus.

27-32. (canceled)
